(19) United States
(12) Patent Application Publication
(10) Pub. No.: US 2008/0126087 A1
(43) Pub. Date: May 29, 2008

(54) Method and systems for information retrieval during communication

(75) Inventor: Fu-Chiang Chou, Taoyuan (TW)

Correspondence Address: BIRCH STEWART KOLASCH & BIRCH, PO BOX 747, FALLS CHURCH, VA, 22040-0747, US

(73) Assignee: HIGH TECH COMPUTER, CORP.

(21) Appl. No.: 11/882,902

(22) Filed: Aug. 7, 2007

(30) Foreign Application Priority Data
Nov. 27, 2006 (TW) 95143719

(51) Int. Cl. G10L 15/00; G10L 13/00

(52) U.S. Cl. 704/231; 704/258; 704/E13.001

(57) ABSTRACT

Methods and systems for information retrieval during communication for use in a device having telecommunication capability. The device performs a communication. An instruction is received during the communication. Information is retrieved according to the instruction. The information is converted to speech using a text-to-speech technology, and the speech is provided to at least one party corresponding to the communication.

### BACKGROUND OF THE INVENTION

1. Field of the Invention

The disclosure relates generally to methods and systems for information retrieval during communication and, more particularly to methods and systems for information retrieval during communication using text-to-speech and/or voice-recognition technologies.

2. Description of the Related Art

Recently, handheld devices have become more and more advanced and multi-functional. For example, a handheld device may provide communication capability, email access, advanced address book management, media playback, Internet access capability, and various other applications. Using these applications, users can record information such as address book information comprising phone numbers and contact address information, email address, and calendars and schedules in the device. With the convenience of the functions and devices, handheld devices have become important tools for everyday life.

In many instances, users need to retrieve information during the course of communication on the handheld device. For example, a called party may request a phone number of a third party during the course of a phone call between the caller and the called party. Since the phone number of the third party is recorded in the device, the phone number must be retrieved from the device. Conventionally, this process often proves to be time-consuming because users are required to put the called party on hold for seconds or even minutes, search for the required information using the input device of the device, memorize it, and then relay the details back to the called party. During this process, many users may forget important details and have to retrieve the information again and again. This long, drawn out process to retrieve information wastes time for both parties, money for the caller, and effort for the information searcher.

### BRIEF SUMMARY OF THE INVENTION

Methods and systems for information retrieval during communication are provided.

In an embodiment of a method for information retrieval during communication for use in a device having telecommunication capability, a communication is performed. An instruction is received during the communication. Information is retrieved according to the instruction. The information is converted to speech, and the speech is prompted to at least one participant.

An embodiment of a system for information retrieval during communication comprises at least a processing unit. During communication, the processing unit retrieves information according to an instruction. The processing unit converts the information to speech, and provides the speech to at least one party corresponding to the communication.

Methods and systems for information retrieval during communication may take the form of program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a system for information retrieval during communication;

FIG. 2 is a flowchart of an embodiment of a method for information retrieval during communication;

FIG. 3 is a flowchart of an embodiment of a method for information retrieval during communication; and

FIG. 4 is a flowchart of an embodiment of a method for information retrieval during communication.

### DETAILED DESCRIPTION OF THE INVENTION

Methods and systems for information retrieval during communication are provided.

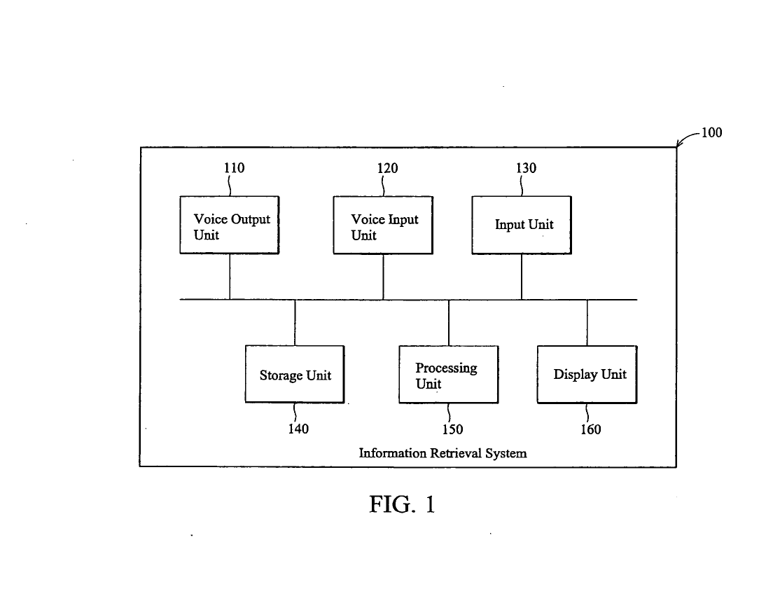

FIG. 1 is a schematic diagram illustrating an embodiment of a system for information retrieval during communication.

The information retrieval system 100 may be a device having telecommunication capability, such as a fixed phone or a mobile phone. The information retrieval system 100 comprises a voice output unit 110, a voice input unit 120, an input unit 130, a storage unit 140, a processing unit 150, and a display unit 160. The voice output unit 110 may be an earphone or a speaker. The voice input unit 120 may be a microphone. The input unit 130 may be a keypad or a touch-sensitive mechanism on the device. The storage unit 140 may comprise information such as an address book and schedules. The address book records information such as phone number, image, address and email address of contact persons. The processing unit 150 controls operation of components of the information retrieval system 100, and performs the method for information retrieval during communication. It is noted that the information retrieval system 100 can couple to a network such as Internet to access related information. The display unit 160 may be a screen of the device for display related information.

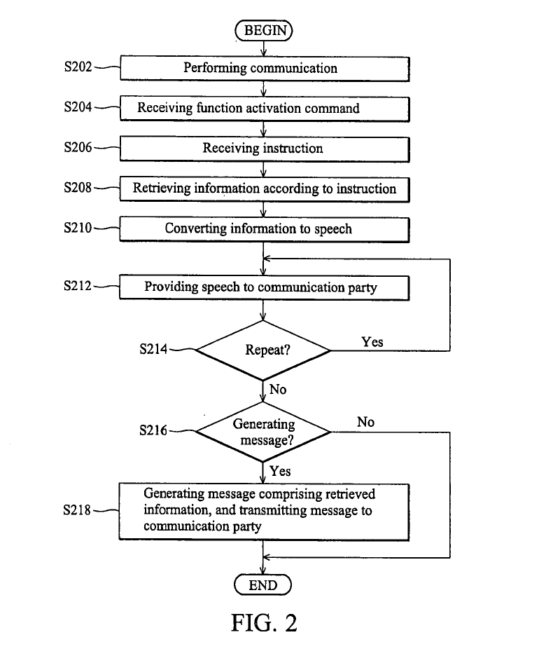

FIG. 2 is a flowchart of an embodiment of a method for information retrieval during communication for use in a device having telecommunication capability.

In step S202, the device communicates with at least one called party. In step S204, a function activation command is received. It is noted that the function activation command can be generated if information needs to be retrieved, and corresponding instructions can be received by the device correspondingly. In step S206, an instruction is received, and in step S208, information is retrieved according to the instruction. It is understood that the instruction may request to retrieve phone number, image, address, and/or email address of a specific contact person, or a schedule of a specific date. The information can be retrieved from the storage unit 140. In some embodiments, the information can be retrieved by searching from the network coupled with the device. Thereafter, in step S210, the retrieved information is converted to speech according to a text-to-speech technology, and in step S212, the speech is output via the voice output unit 110, and provided (transmitted) to the called party via base band and RF (Radio Frequency) channels. In step S214, it is determined whether the speech needs to be provided again. If so, the procedure returns to step S212. If not, in step S216, it is determined whether a message needs to be generated and transmitted to the called party. If not, the procedure is complete. If so, in step S218, a message comprising the retrieved information is generated and transmitted to a communication device of the called party. It is noted that, in some embodiments, the device can also transmit the retrieved information to the communication device of the called party via a data transmission manner, or transmit an email message comprising the retrieved information to an email recipient of the called party. In some embodiments, the retrieved information can be displayed in the display unit 160.

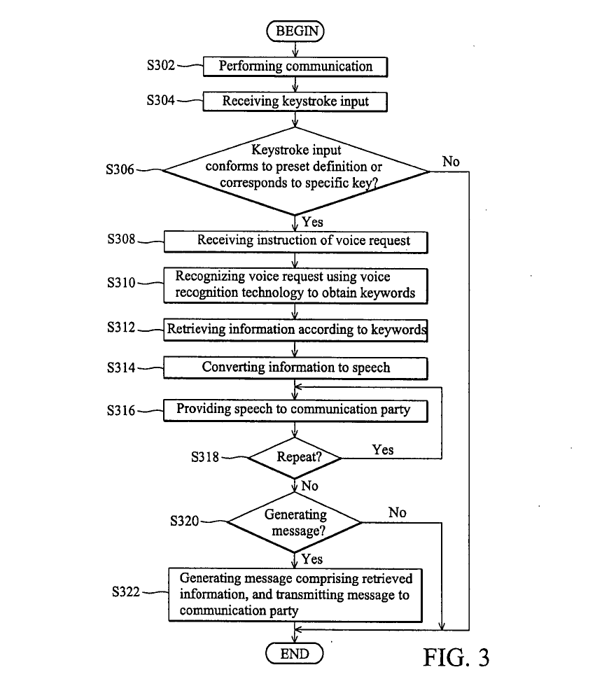

FIG. 3 is a flowchart of an embodiment of a method for information retrieval during communication for use in a device having telecommunication capability. In this embodiment, the function activation command can be generated according to a keystroke input via the input unit 130 or a specific key set on the device.

In step S302, the device communicates with at least one called party. In step S304, a keystroke input is received. It is understood that the keystroke input may be a single key input or a combination of key inputs. In step S306, it is determined whether the keystroke conforms to a preset definition, such as preset password, or whether the keystroke corresponds to a specific key. If not, the procedure is complete. If so, in step S308, an instruction of a voice request is received via the voice input unit 120. In step S310, the voice request is recognized using an Automatic Speech Recognition technology to obtain at least one keyword, and in step S312, information is retrieved according to the keyword. Similarly, the instruction may request to retrieve phone number, image, address, and/or email address of a specific contact person, or a schedule of a specific date. The information can be retrieved from the storage unit 140 or the network coupled with the device. Thereafter, in step S314, the retrieved information is converted to speech according to a text-to-speech technology, and in step S316, the speech is provided (transmitted) to the called party. In step S318, it is determined whether the speech needs to be provided again. If so, the procedure returns to step S316. If not, in step S320, it is determined whether a message needs to be generated and transmitted to the called party. If not, the procedure is complete. If so, in step S322, a message comprising the retrieved information is generated and transmitted to a communication device of the called party.

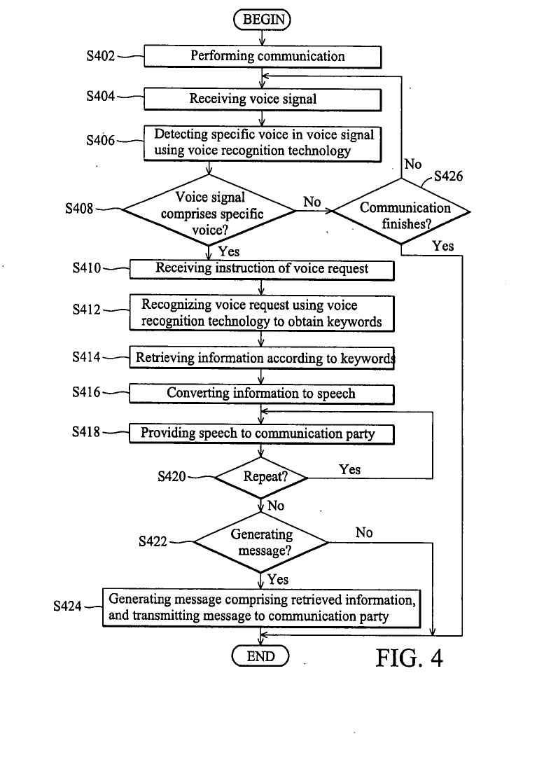

FIG. 4 is a flowchart of an embodiment of a method for information retrieval during communication for use in a device having telecommunication capability. In this embodiment, the function activation command can be generated according to a specific voice.

In step S402, the device communicates with at least one called party. In step S404, a voice signal is received via the voice input unit 120. In step S406, the voice signal is recognized using an Automatic Speech Recognition technology, thus to determine whether a specific voice is included in the voice signal. If the voice signal does not comprise the specific voice (No in step S408), in step S426, it is determined whether the communication is complete. If so, the procedure is complete. If not, the procedure returns to step S404. If the voice signal comprises the specific voice (Yes in step S408), in step S410, an instruction of a voice request is received via the voice input unit 120. In step S412, the voice request is recognized using the Automatic Speech Recognition technology to obtain at least one keyword, and in step S414, information is retrieved according to the keyword. Similarly, the instruction may request a phone number, image, address, and/or email address of a specific contact, or a schedule of a specific date. The information can be retrieved from the storage unit 140 or the network coupled with the device. Thereafter, in step S416, the retrieved information is converted to speech according to a text-to-speech technology, and in step S418, the speech is provided (transmitted) to the called party. In step S420, it is determined whether the speech needs to be provided again. If so, the procedure returns to step S418. If not, in step S422, it is determined whether a message needs to be generated and transmitted to the called party. If not, the procedure is complete. If so, in step S424, a message comprising the retrieved information is generated and transmitted to a communication device of the called party.

For example, the voice request may be “Michael's phone number”. The voice request can be recognized to generate keywords comprising “Michael” and “phone number”. The information retrieved from an address book based on the keywords “Michael” and “phone number” may be “0910 666 999”. In some embodiments, the conversed voice may be “0910 666 999” or “Michael's phone number is 0910 666 999”. During communication, the called party can be informed of the phone number of Michael, and write it down. In some embodiments, the called party can directly add the received phone number to its address book since the retrieved information can be transmitted to the called party via message, data transmission, and/or email. Additionally, the voice request may be “Tomorrow's schedule”. The voice request can be recognized to generate keywords comprising “Tomorrow” and “schedule”. The information retrieved from a calendar based on the keywords “Tomorrow” and “schedule” may be two schedules “10:00 AM to 12:00 AM and 2:00 PM to 4:00 PM”. In some embodiments, the conversed voice may be “10:00 AM to 12:00 AM and 2:00 PM to 4:00 PM” or “Tomorrow has two schedules. One is from 10:00 AM to 12:00 AM and another is from 2:00 PM to 4:00 PM”. It is understood that the conversed voice can be edited and provided based on the retrieved information, and adjusted according to various requirements. During communication, the parties can be aware of the schedules of tomorrow, and continue to arrange their schedule.

Methods and systems for information retrieval during communication, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for information retrieval during communication for use in a device having telecommunication capability, comprising:
performing a communication;
receiving an instruction during the communication;
retrieving information according to the instruction; and
converting the information to speech, and providing the speech to at least one party corresponding to the communication.

2. The method of claim 1 further comprising:
receiving a keystroke; and
receiving the instruction in response to the keystroke.

3. The method of claim 2 further comprising:
determining whether the keystroke conforms to a preset definition or corresponds to a specific key of the device; and
if so, receiving the instruction.

4. The method of claim 1 further comprising:
receiving a voice signal; and
receiving the instruction in response to the voice signal.

5. The method of claim 4 further comprising:
recognizing the voice signal using a voice recognition technology;
determining whether the voice signal comprises a specific voice; and
if so, receiving the instruction.

6. The method of claim 1 further comprising receiving the instruction by receiving a voice request.

7. The method of claim 6 further comprising:
recognizing the voice request using a voice recognition technology to obtain at least one keyword; and
retrieving the information according to the keyword.

8. The method of claim 1 further comprising:
generating a message comprising the retrieved information; and
transmitting the message to the at least one party.

9. The method of claim 1 further comprising:
receiving a command; and
providing the speech to the at least one party again in response to the command.

10. The method of claim 1 wherein the information comprises phone number, address, email address, or schedule.

11. The method of claim 1 further comprising retrieving the information from a network coupled with the device according to the instruction.

12. A system for information retrieval during communication, comprising:
a processing unit retrieving information according to an instruction during a communication, converting the information to speech, and providing the speech to at least one party corresponding to the communication.

13. The system of claim 12 further comprising an input unit for receiving a keystroke, and the processing unit receiving the instruction in response to the keystroke.

14. The system of claim 13 wherein the processing unit further determines whether the keystroke conforms to a preset definition or corresponds to a specific key of the device, and if so, receives the instruction.

15. The system of claim 12 further comprising a voice input unit receiving a voice signal, and the processing unit receives the instruction in response to the voice signal.

16. The system of claim 15 wherein the processing unit further recognizes the voice signal using a voice recognition technology, determines whether the voice signal comprises a specific voice, and if so, receives the instruction.

17. The system of claim 12 further comprising a voice input unit receiving the instruction comprising a voice request.

18. The system of claim 17 wherein the processing unit further recognizes the voice request using a voice recognition technology to obtain at least one keyword; and retrieves the information according to the keyword.

19. The system of claim 12 wherein the processing unit further generates a message comprising the retrieved information, and transmits the message to the at least one party.

20. The system of claim 12 wherein the processing unit further provides the speech to the at least one party again in response to a command.

21. The system of claim 12 wherein the information comprises phone number, address, email address, or schedule.

22. The system of claim 12 wherein the processing unit further retrieves the information from a network according to the instruction.

23. A machine-readable storage medium comprising a computer program, which, when executed, causes a device to perform a method for information retrieval during communication, the method comprising:
performing a communication;
receiving an instruction during the communication;
retrieving information according to the instruction; and
converting the information to speech, and providing the speech to at least one party corresponding to the communication.
